(19) United States
(12) Patent Application Publication
(10) Pub. No.: US 2024/0157946 A1
(43) Pub. Date: May 16, 2024

(54) VEHICLE CONTROL DEVICE

(71) Applicant: TOYOTA JIDOSHA KABUSHIKI KAISHA, Toyota-shi (JP)

(72) Inventor: Hiroto KATSUDA, Toyota-shi (JP)

(73) Assignee: TOYOTA JIDOSHA KABUSHIKI KAISHA, Toyota-shi (JP)

(21) Appl. No.: 18/466,044

(22) Filed: Sep. 13, 2023

(30) Foreign Application Priority Data
Nov. 16, 2022 (JP) 2022-183292

(51) Int. Cl. B60W 30/18; G06V 20/56

(52) U.S. Cl. CPC B60W 30/18163; G06V 20/588; B60W 2420/42; B60W 2554/80

(57) ABSTRACT

The vehicle control device includes an imaging device capable of capturing an image of a lane marking line and acquiring lane marking line information, and a control unit capable of executing lane tracing assist control that assists a steering operation of a driver of the vehicle. The control unit is configured to switch a target position from the predetermined first position in the first lane to the predetermined second position in the second lane when the predetermined specific condition including the predetermined first condition that is satisfied when the intention to change the lane in the predetermined direction of the driver is detected during execution of the lane tracing assist control in the first lane and the predetermined second condition that is satisfied when there is a high possibility that the second lane adjacent to the first lane in the predetermined direction is present.

### CROSS-REFERENCE TO RELATED APPLICATION

This application claims priority to Japanese Patent Application No. 2022-183292 filed on Nov. 16, 2022, incorporated herein by reference in its entirety.

### BACKGROUND

### 1. Technical Field

The present disclosure relates to a vehicle control device capable of executing a lane change by lane tracing assist control.

### 2. Description of Related Art

Conventionally, a vehicle control device (hereinafter, also referred to as a “conventional device”) capable of executing Lane Tracing Assist control (LTA) is known (see Japanese Unexamined Patent Application Publication No. 2013-233930 (JP 2013-233930 A)). The lane tracing assist control is control that assists a steering operation of a driver of a vehicle so that the traveling position of the vehicle is maintained at a predetermined target position (typically, a center position) in the lane width direction of the lane. Hereinafter, the lane tracing assist control is also referred to as “LTA”. The conventional device executes the LTA when a predetermined execution condition is satisfied. The execution condition includes that the right and left lane marking lines defining the lane are detected (recognized) by a camera sensor.

### SUMMARY

When a predetermined operation (for example, a turn signal lever operation and/or a steering operation) by the driver is detected while the LTA is being executed, the conventional device is configured to determine that the driver wants to change the lane and temporarily stop the LTA. With the above, the driver can change the lane from the current lane to the adjacent lane by the driver's driving operation (hereinafter, the lane change by the driver's driving operation is also referred to as a “manual lane change”).

During the execution of the manual lane change, the conventional device constantly determines whether the execution condition of the LTA is satisfied, and resumes the LTA when it is determined that the execution condition is satisfied. Here, the imaging range of the camera sensor is mainly limited to the area forward of the vehicle. Therefore, depending on the trajectory of the manual lane change, the camera sensor may not be able to quickly detect the right and left lane marking lines defining the adjacent lane. Satisfaction of the execution condition of the LTA is late. As a result, the LTA may not be resumed at the timing expected by the driver. Further, when the vehicle enters the adjacent lane at a relatively large yaw angle by the manual lane change, and the driver does not perform the driving operation in expectation of resumption of the LTA, the camera sensor cannot detect the right and left lane marking lines of the adjacent lane. As a result, the vehicle may deviate from the adjacent lane (in other words, traverse the adjacent lane). In these cases, there arises an issue in that, since the LTA is not resumed as expected by the driver, the lane change cannot be appropriately executed during the execution of the LTA.

The present disclosure has been made to address the above-mentioned issue. That is, an object of the present disclosure is to provide a vehicle control device capable of appropriately executing a lane change during execution of lane tracing assist control.

A vehicle control device according to the present disclosure (hereinafter, referred to as “the present disclosure device”) includes: an imaging device that is able to capture an image of a lane marking line extending in front of a vehicle and acquire lane marking line information related to the lane marking line; and a control unit that is able to execute lane tracing assist control that assists a steering operation of a driver of the vehicle such that a traveling position of the vehicle is maintained at a predetermined target position in a lane width direction of a lane, based on the lane marking line information. The control unit is configured to, during execution of the lane tracing assist control in a first lane, when a predetermined specific condition including a predetermined first condition that is satisfied when a lane change intention of the driver toward a predetermined direction is detected, and a predetermined second condition that is satisfied when there is a high possibility that a second lane adjacent to the first lane in the predetermined direction is present, is satisfied, switch the target position from a predetermined first position in the first lane to a predetermined second position in the second lane.

The present disclosure device switches the target position from the first position in the first lane to the second position in the second lane, when the specific condition including the first condition (a condition that is satisfied when the lane change intention of the driver toward the predetermined direction is detected), and the second condition (a condition that is satisfied when there is a high possibility that the second lane adjacent to the first lane in the predetermined direction is present), is satisfied during execution of the lane tracing assist control in the first lane. That is, when the specific condition is satisfied, the present disclosure device changes the lane from the first lane to the second lane by the lane tracing assist control instead of stopping the lane tracing assist control. With this configuration, since the lane change is executed in a smooth trajectory, the lane change can be executed in a manner more suitable for the driver's sense. As a result, the lane change can be appropriately executed during the execution of the lane tracing assist control. In addition, even in a vehicle control device that is not provided with the lane change assistance control function, the lane change can be executed with a simple configuration by the lane tracing assist control.

One aspect of the present disclosure further includes a vehicle state information acquisition device that is able to acquire vehicle state information related to a vehicle state of the vehicle. The control unit is configured to: during the execution of the lane tracing assist control in the first lane, sequentially calculate a length of a portion of the vehicle in the lane width direction, the portion being a portion that is estimated to deviate from the first lane after a predetermined specific time elapses, as an estimated deviation length, based on the lane marking line information and the vehicle state information; and when the estimated deviation length is equal to or greater than a predetermined deviation length threshold value, detect the lane change intention in which an estimated deviation direction of the vehicle is the predetermined direction.

With this configuration, it is possible to quickly and accurately detect the lane change intention of the driver by setting each of the specific time and the deviation length threshold value to an appropriate value.

In the aspect of the present disclosure, the control unit is configured to, when the specific condition is satisfied during the execution of the lane tracing assist control in the first lane, set a position shifted, from the first position, in the predetermined direction along the lane width direction by a lane width of the first lane that is calculated based on first lane marking line information, as a second position and continue the lane tracing assist control, until second lane marking line information is acquired, and set a predetermined position in the second lane that is calculated based on the second lane marking line information, as the second position, after the second lane marking line information is acquired, the first lane marking line information being information on right and left lane marking lines defining the first lane, and the second lane marking line information being information on right and left lane marking lines defining the second lane.

In general, the execution condition of the lane tracing assist control includes that the right and left lane marking lines defining the lane are detected by the imaging device. This is for calculating the target position based on the right and left lane marking lines. However, when the specific condition is satisfied, the vehicle is located in the first lane. Therefore, depending on the position and orientation of the vehicle, the imaging range of the imaging device, and the positional relationship with another vehicle present in the second lane, only one of the right and left lane marking lines defining the second lane may be able to be detected, and the second position may not be able to be appropriately calculated. Therefore, in the aspect of the present disclosure, it is configured that, when the specific condition is satisfied, the second position is calculated based on the first position and the lane width of the first lane, until the second lane marking line information is acquired. With this configuration, the second position can be appropriately calculated even when only one of the lane marking lines of the second lane is detected, and the lane change by the lane tracing assist control can be appropriately executed.

The aspect of the present disclosure further includes a side object detection device that is able to detect an object present on a lateral side of the vehicle. The specific condition further includes a predetermined third condition that is satisfied when an obstruction object that is highly likely to obstruct a lane change of the vehicle is not detected on the second lane by the side object detection device.

With this configuration, it is possible to more safely execute the lane change during the execution of the lane tracing assist control.

In the above description, the signs used in the embodiment are bracketed for the component requirements of the disclosure corresponding to the embodiment to help understanding of the disclosure. However, each component requirement of the disclosure is not limited to the embodiment specified by the above signs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device (the present embodiment) according to an embodiment of the present disclosure;

FIG. 2 is a diagram illustrating a trajectory of vehicles when a lane change is performed by a LTA during LTA;

FIG. 3 is a flow chart illustrating the routine executed by CPU of the vehicle-control ECU;

FIG. 4 is a flow chart showing a routine executed by CPU of the vehicle control ECU of the vehicle control device according to the modification of the present disclosure;

FIG. 5 is a diagram illustrating a trajectory of vehicles when a manual lane change is performed during LTA by a conventional device; and

FIG. 6 is a diagram illustrating a trajectory of vehicles when a lane change is performed by a LCA during LTA by a conventional device.

### DETAILED DESCRIPTION OF EMBODIMENTS

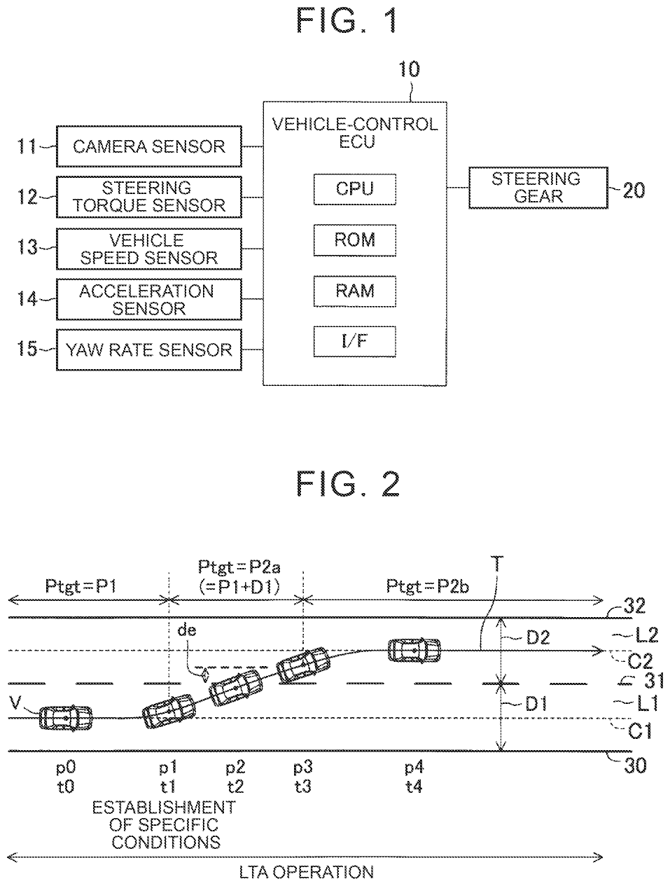

Hereinafter, a vehicle control device (hereinafter, also referred to as “the present embodiment device”) according to an embodiment of the present disclosure will be described with reference to the drawings. The present embodiment is mounted on a vehicle. As illustrated in FIG. 1, the present embodiment includes a vehicle control ECU 10, a camera sensor 11 connected thereto, a steering torque sensor 12, a vehicle speed sensor 13, an acceleration sensor 14, a yaw rate sensor 15, and a steering device 20. The vehicle control ECU 10 includes a microcomputer as a main part. The microcomputer includes a central processing unit (CPU), read-only memory (ROM), random access memory (RAM), an interface (UF), and the like. The CPU realizes various functions by executing instructions (programs, routines) stored in the ROM. Note that some of these functions may be executed by another ECU (not shown).

The vehicle control ECU 10 is configured to acquire signals outputted from the sensors 11 to 15 every time a predetermined period elapses, and control the steering device 20 based on the acquired signals. Hereinafter, the vehicle-control ECU 10 is also simply referred to as “ECU 10”.

The camera sensor 11 (imaging device) is installed on the rear surface of the inner mirror of the vehicle. The camera sensor 11 captures an image of a scene in front of the vehicle, and detects a three-dimensional object existing in front of the vehicle as a target based on the captured image data. The target object includes a stationary object and a moving object. The stationary object is, for example, a structure such as a guardrail, a curb, and a central separation zone. The moving object is, for example, another vehicle. When the target is detected, the camera sensor 11 calculates a relative relationship (relative position and relative speed of the target with respect to the vehicle) between the vehicle and the target. The camera sensor 11 outputs the calculation result to ECU 10 as target information.

Further, the camera sensor 11 detects a lane marking line extending in front of the vehicle based on the image data. The lane marking lines include solid-line lane marking lines and broken-line lane marking lines. The solid line lane marking line is a lane marking line continuously marked on the road, and includes a white lane marking line and a yellow lane marking line. The broken line lane marking line is a lane marking line intermittently marked at a predetermined interval on the road, and includes a white lane marking line. Herein, an area between two adjacent lane marking lines is defined as a lane. The imaging range of the camera sensor 11 is sized to include at least the left and right lane marking lines that define the current lane (the lane in which the vehicle is currently located). When the lane marking line is detected, the camera sensor 11 calculates the type of the lane marking line, the distance between two adjacent lane marking lines (that is, the lane width), and the shape of the lane marking line. In addition, the camera sensor 11 calculates the position and orientation (in other words, yaw angle) of the vehicle in the lane. In the present embodiment, the position of the vehicle is a center position in a plan view of the vehicle, but the present disclosure is not limited to this configuration, and may be, for example, a center of gravity position of the vehicle. The camera sensor 11 outputs the result of the calculation to ECU 10 as lane marking line information. In the following description, the target information and the lane marking line information may be collectively referred to as “camera information”.

The steering torque sensor 12 detects a steering torque corresponding to a steering operation (an operation of a steering wheel) of the driver, and outputs a detection signal to ECU 10.

The vehicle speed sensor 13 detects the speed (vehicle speed) of the vehicle. The acceleration sensor 14 detects an acceleration of the vehicle. The yaw rate sensor 15 detects a yaw rate of the vehicle. The turning direction of the vehicle corresponds to the sign of the yaw rate. The sensors 13 to 15 output a detection signal to ECU 10. Since the vehicle speed, acceleration, and yaw rate respectively detected by the sensors 13 to 15 are information related to the vehicle state of the vehicle, the information is hereinafter referred to as “vehicle state information”. The sensors 13 to 15 correspond to an example of a “vehicle state information acquisition device”.

The steering device 20 is a device for applying a steering torque for turning the steered wheels of the vehicle to a steering mechanism (not shown). ECU 10 controls the steering torque (and thus the steering angle of the steered wheels) applied to the steering mechanisms by performing steering control for controlling the operation of the steering device 20. In addition, ECU 10 applies the steering assist torque corresponding to the steering torque acquired from the steering torque sensor 12 to the steering system.

ECU 10 is configured to be capable of executing a lane change by a LTA in addition to the well-known lane tracing assist control (LTA). Hereinafter, the operation of ECU 10 will be described. In principle, when the following conditions a and b are satisfied, ECU 10 determines that LTA execution condition is satisfied and executes LTA.
(Condition a) Adaptive Cruise Control (ACC) is being executed.
(Condition b) The left and right lane marking lines defining the lane are detected based on the lane marking line information.

Adaptive cruise control (hereinafter also referred to as “ACC”) is a well-known control. In this control, when the preceding vehicle is detected based on the camera information, the vehicle speed is controlled so that the inter-vehicle distance (or the inter-vehicle time) from the preceding vehicle matches the predetermined set inter-vehicle distance (or the set inter-vehicle time). This control controls the vehicle speed so that the vehicle travels at a predetermined set vehicle speed when no preceding vehicle is detected. In the present embodiment, it is assumed that the condition a is always satisfied.

When it is determined that LTA execution-condition is satisfied, ECU 10 calculates the center position in the lane-width direction (hereinafter, also referred to as “lateral direction”) of the lane as the target position on the basis of the lane marking line information (more specifically, the left and right lane marking lines). Then, LTA is executed by controlling the steering device 20 so that the traveling position of the vehicles is maintained at the target position. Here, “the traveling position of the vehicle is maintained at the target position” means “the vehicle is located at the center in the lateral direction of the lane and the yaw angle is maintained at approximately zero”. That is, while LTA is being executed, ECU 10 calculates a target steering angle such that the vehicle is located at the target position and the present yaw angle matches the target yaw angle, and controls the steering device 20 so that a steering torque such that the steering angle of the steered wheels matches the target steering angle is applied to the steering mechanisms. The target position is not limited to the center position, and may be set to a position shifted laterally by a predetermined distance from the center position.

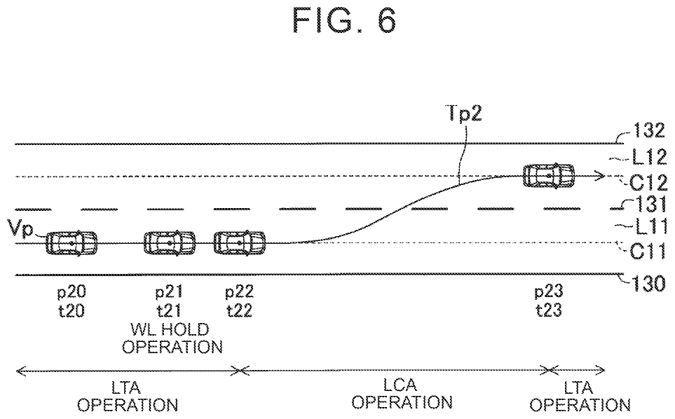

The problem of the conventional apparatus will now be described with reference to FIG. 5 and FIG. 6. The conventional device determines that the driver wants to change the lane and temporarily stops LTA when a predetermined operation (for example, an operation of the blinker lever WL and/or a steering operation) is detected by the driver during LTA. As a result, the driver can perform lane change (manual lane change) by the driver's own driving operation. The conventional device resumes LTA when the execution condition of LTA is satisfied again during execution of the manual lane change. According to this configuration, depending on the trajectory of the manual lane change, there is a possibility that the resumption of LTA is delayed or that the vehicles deviate from the lane (the lane after the manual lane change) without resuming LTA.

FIG. 5 is a diagram illustrating a trajectory Tp1 of a vehicle Vp (a vehicle equipped with a conventional device) when LTA is not resumed. The positions p10 to p15 respectively indicate the traveling positions of the vehicle Vp at the corresponding time points t10 to t15. The lane L11 is defined by lane marking lines 130 and 131. The lane L12 is defined by lane marking lines 131 and 132. The line C11 is an imaginary line formed by a set of position P11 (not shown) which is a lateral center position of the lane L11. The line C12 is an imaginary line formed by a set of position P12 (not shown) which is a lateral center position of the lane L12.

As shown in FIG. 5, the conventional device executes LTA so that the position p10 of the vehicle Vp is maintained at the position P11 of the lane L11 at the time point t10. In this case, an operation of the blinker lever WL (more specifically, an operation for blinking the blinker) is performed by the driver at the time point t11. Accordingly, the conventional device determines that the driver intends to change the lane, and temporarily stops LTA at the time point t11. The driver starts the manual lane change from the lane L11 to the lane L12 at the time point t11, and stops the driving so as to expect the resumption of LTA at a time point t12 that is a time point at which the vehicle Vp finishes crossing the lane marking line 131. In this case, since the vehicle Vp enters the lane L12 at a relatively large yaw angle, the camera sensor (not shown) can detect only the lane marking line 132, and LTA is not resumed. Consequently, the vehicle Vp travels straight while maintaining the yaw angle and deviates from the lane L12. In this case, at the time point t13, the driver notices a lane departure of the vehicle Vp and resumes the driving operation. As a result, the lane marking lines 131 and 132 are detected by the camera sensor at the time point t14. That is, LTA execution condition is satisfied. Consequently, LTA is resumed at the time point t14. At the time point t15, the conventional device executes LTA so that the position p15 of the vehicle Vp is maintained at the position P12 of the lane L12.

In this way, when the driver's intent to change the lane is detected during the execution of the LTA and LTA is temporarily stopped during Vp of L12 of the lane, LTA is not resumed as expected by the driver. Therefore, there arises a problem that the lane change cannot be appropriately performed. Similar issues may arise if LTA resume is delayed.

On the other hand, FIG. 6 is a diagram exemplifying a trajectory Tp2 of the vehicle Vp when Lane Change Assist control (LCA) of LTA is executed. The positions p20 to p23 respectively indicate the traveling positions of the vehicle Vp at the corresponding time points t20 to t23. The lane change assistance control is a well-known control. This control assists the driver's steering operation so that the vehicle moves along a predetermined target trajectory from the current lane to the adjacent lane over a predetermined target lane change time. Hereinafter, the lane change support control is also referred to as “LCA”. LCA includes an operation in which the blinker lever WL is held at a predetermined position for a predetermined holding period (for example, 1 second) by the driver (hereinafter, this operation is also referred to as a “blinker lever holding operation”). As shown in FIG. 6, the conventional device executes LTA so that the position p20 of the vehicle Vp is maintained at the position P11 of the lane L11 at the time point t20. In this case, the blinker lever holding operation is started by the driver at the time point t21. LCA is executed when the holding period has elapsed at the time point t22. As a result, the conventional device calculates a target trajectory starting from the position p22 and ending from the position p23, and executes LCA over the target lane change period. When LCA ends at the time point t23, the conventional device resumes LTA so that the position p23 of the vehicle Vp is maintained at the position P12 of the lane L12.

Incidentally, the target lane change times of LCA are set to be relatively large in order to comply with international laws and regulations. In addition, in order for LCA to be executed, at least a time equal to or longer than the holding time is required. Therefore, when LCA execution condition is satisfied and the lane change by LCA is executed during the execution of LTA, the driver may be troublesome due to “a long time is required for the lane change and a long time is required until the lane change is started”.

As described above, according to the configuration of the conventional device, it is difficult to say that the lane change performed during the execution of LTA is performed in a manner adapted to the feeling of the driver. There was room for improvement. Therefore, in the present embodiment, ECU 10 is configured to perform the lane change by LTA instead of stopping LTA when a predetermined specifying condition (described later) including the driver's intent to change the lane is satisfied during LTA. Hereinafter, the lane where LTA is currently executed is referred to as a lane L1 (first lane).

The specific condition includes the following condition 1 (first condition) and condition 2 (second condition). When Condition 1 and Condition 2 are satisfied, ECU determines that the specified condition is satisfied.
(Condition 1) A lane change intention in a predetermined direction (left direction or right direction) of the driver is detected on the basis of the lane marking line information and the vehicle state information.
(Condition 2) It is highly likely that there is a lane L2 (second lane) adjoining the lane L1 in a predetermined direction.

First, Condition 1 will be described. ECU 10 calculates the vehicle speed and the acceleration in the lateral direction of the lane L1 as the lateral speed and the lateral acceleration, respectively, on the basis of the lane marking line information and the vehicle status information while LTA in the lane L1 is being executed. Then, ECU 10 estimates the lateral movement amount (lateral movement amount) of the vehicle when it is assumed that the vehicle travels for a predetermined specified time (1 second in the present embodiment) while the lateral speed, the lateral acceleration, and the yaw rate at the present time are maintained. Subsequently, ECU 10 calculates an estimated lateral position, which is a lateral position of the vehicle after a specified period of time, by laterally shifting a lateral position (a position in the lateral direction) of the vehicle at the current point of time by a lateral movement amount. ECU 10 then computes, based on the estimated lateral position, an estimated deviation length from the lane L1 of the vehicle (i.e., the lateral length of the part where the vehicle is estimated to be deviating from the lane L1). ECU 10 sequentially executes the series of processes described above, and determines that the driver has the lane change intention having the estimated deviation direction of the vehicle as the predetermined direction at the time when the estimated deviation length de becomes equal to or larger than the predetermined deviation length threshold deth (in other words, detects the lane change intention of the driver when the estimated deviation length de is equal to or larger than the deviation length threshold deth), and determines that the condition 1 is satisfied. The deviation length thresholds deth are correlated with particular times and are set to 0.7 m in this embodiment. However, the values of the specified time and the deviation length threshold deth are not limited to these values, and may be appropriately set based on experimentation or simulations.

Next, Condition 2 will be described. Condition 2 is introduced to determine whether a lane changeable lane (lane L2) exists. ECU 10 determines whether or not the lane L2 is present based on the type of the predetermined direction-side lane marking line among the left and right lane marking lines defining the lane L1 included in the lane marking line information. For example, when the type of the lane marking line is a white broken line lane marking line or a solid line lane marking line (that is, a lane marking line in which a lane change is permitted), ECU 10 determines that the lane L2 is highly likely to be present, and determines that the condition 2 is satisfied. At this time, ECU 10 may additionally determine whether or not a structural object exists behind the lane marking line based on the target object data. When a structure is present behind the lane marking line, ECU 10 may determine that the lane L2 is unlikely to be present even if the type of the lane marking line is “lane marking line permitted to change lane”. If the lane marking line information includes the left and right lane marking lines that define the lane L2, ECU 10 may determine that the condition 2 is satisfied without performing the above determination.

FIG. 2 is a diagram exemplifying the trajectory T of the vehicle V when a leftward lane change is performed by LTA during LTA in the lane L1. The positions p0 to p4 respectively indicate the traveling positions of the vehicles Vp at the corresponding time points t0 to t4. The lane L1 is defined by the lane marking lines 30 and 31, and the lane L2 is defined by the lane marking lines 31 and 32. The line C1 is an imaginary line formed by a set of position P1 (not shown) which is a lateral center position of the lane L1. The line C2 is an imaginary line formed by a set of position P2b (not shown) which is a lateral center position of the lane L2.

As illustrated in FIG. 2, ECU 10 executes LTA so that the position p0 of the vehicle V is maintained at the position P1 of the lane L1 at the time point t0. ECU 10 calculates the position P1 based on the “lane marking line information regarding the two lane marking lines 30 and 31 of the lane L1”. Hereinafter, the lane marking line information is also referred to as “first lane marking line information”. In this case, the specified condition is satisfied at the time point t1. That is, Condition 1 is satisfied at the time point t1 when the estimated deviation length de at the time point t2 (the time point after the specified time point from the time point t1) satisfies de deth. Further, the type of the lane marking line 31 included in the lane marking line information acquired at the time point t1 is a white broken line lane marking line. Condition 2 is satisfied at the time point t1 when ECU 10 determines that the lane L2 is likely to exist. When the specified condition is satisfied in this way, ECU 10 switches the target position Ptgt of LTA from the position P1 of the lane L1 to the position P2 of the lane L2.

Specifically, the position P2 includes position P2a and position P2b. The position P2a is a position shifted from the position P1 to the left along the lateral direction by the lane width D1 of the lane L1. The position P2b is a lateral center position of the lane L2. At the time point t1 when the specified condition is satisfied, since the vehicle V is located in the lane L1, only one lane marking line 31 in the lane L2 can be detected depending on the position and orientation of the vehicle V, the imaging range of the camera sensor 11, and the positional relation with other vehicles present in the lane L2. There is a possibility that the center position of the lane L2 in the lateral direction cannot be appropriately calculated. Therefore, in the present embodiment, the position P2a is set as the position P2, LTA is continued, and after the second lane marking line information is acquired, the position P2b is set as the position P2 until the lane marking line information (hereinafter, also referred to as “second lane marking line information”) related to the two lane marking lines 31 and 32 in the lane L2 is acquired. In other words, the condition 2 of LTA executing condition is not satisfied until the second lane marking line information is acquired after the specified condition is satisfied, but ECU 10 is configured to execute LTA exceptionally. When the lane width D1 of the lane L1 and the lane width D2 of the lane L2 are equal to each other, the position P2a and the position P2b coincide laterally.

In the embodiment of FIG. 2, the second lane marking line information is acquired at a time point t3 the time point when the vehicle V finishes straddling the lane marking line 31. Therefore, ECU 10 sets the target position Ptgt from the time point t1 to the time point t3 to the position P2a, and sets the target position Ptgt to the position P2b after the time point t3. Thus, at the time point t4, LTA is executed so that the position p4 of the vehicles V is maintained at the position P2b of the lane L2. According to this configuration, the position P2 can be appropriately calculated even when the second lane marking line information cannot be acquired immediately after the specified condition is satisfied.

When the specified condition is satisfied, the target position Ptgt is switched from the position P1 to the position P2, but when the distance from the position P1 to the position P2 is relatively large, the behavior of the vehicles due to LTA may become unstable. Therefore, in the present embodiment, when the distance from the position P1 to the position P2 is equal to or larger than the predetermined distance threshold, ECU 10 sets n provisional positions Pt1 to Ptn (not shown) at equal intervals between the position P1 and the position P2. The position Ptk+1 is located farther from the vehicle V than the position Ptk (k:1 to n−1). The distance between the position P1 and the position Pt1 and the distance between the position Ptk and the position Ptk+1 are all 0.7 m, for example. When the specified condition is satisfied, ECU 10 sequentially switches the target position from the position P1 to the position P2 via the position Pt1, the position Pt2, the position Ptn−1, and the position Ptn at an appropriate timing. Thus, an appropriate lane change by LTA can be performed.

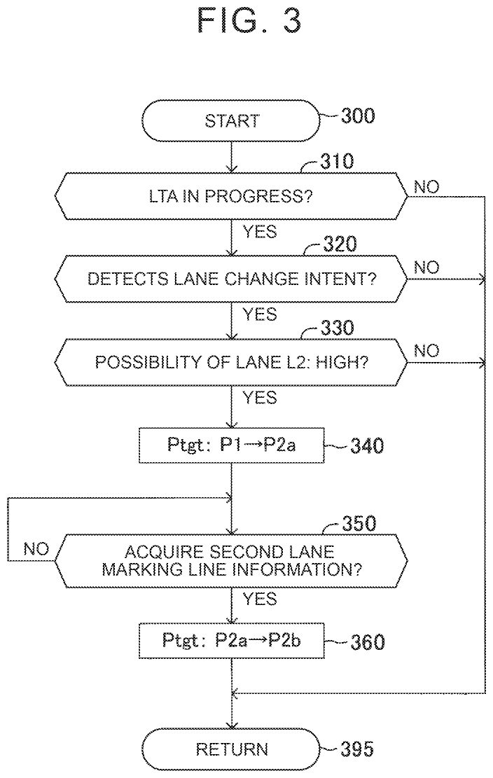

Next, a specific operation of ECU 10 will be described. CPU of ECU 10 performs the routine illustrated by the flow chart of FIG. 3 while the ignition switch is on. At a predetermined timing, CPU proceeds from step 300 to step 310 to determine whether LTA in the lane L1 is being executed. If LTA is being executed (S310: Yes), CPU proceeds to step 320 to determine whether the driver's intent to change the lane has been detected based on the lane marking line information and the vehicle-state information. When the lane change intent is detected (S320: Yes), CPU determines that the condition 1 is satisfied, and proceeds to step 330 to determine whether or not there is a lane L2 (a lane adjoining the lane L1) based on the lane marking line information. If it is highly likely that the lane L2 is present (S330: Yes), CPU determines that the condition 2 is satisfied (that is, the specified condition is satisfied), and the process proceeds to step 340 to continue LTA by switching the target position Ptgt of LTA from the position P1 to the position P2a. Subsequently, CPU determines whether or not the second lane marking line information is acquired. If the second lane marking line information has not been acquired (S350: No), CPU returns to step 350. If the second lane marking line information has been acquired (S350: Yes), CPU proceeds to step 360 and continues LTA by switching the target position Ptgt of LTA from the position P2a to the position P2b. After that, CPU advances the process to step 395 and ends the routine. On the other hand, if LTA in the lane L1 is not executed (S310: No), if the driver's intent to change the lane is not detected (S320: No), or if the lane L2 is unlikely to exist (S330: No), CPU advances the process to step 395 and terminates the routine once.

As described above, the present embodiment changes the lane by LTA instead of stopping LTA when the specified condition is satisfied. According to this configuration, lane change can be performed in a smooth trajectory. Further, as compared with the lane change by LCA, the time required for the lane change can be shortened, and the lane change can be started quickly. Therefore, the lane change can be performed in a manner more suitable for the driver's feeling, and the lane change can be appropriately performed while LTA is being performed. In addition, even in a vehicle control device that does not have a LCA function, the lane can be changed by LTA with a simple configuration. The present disclosure is also applicable to a vehicle control device having a LCA function. In this case, the driver can select either “lane change by LTA” or “lane change by LCA” based on his or her preference or the surrounding environment.

In addition, the present embodiment does not determine whether or not there is an obstruction target (a target that is highly likely to obstruct lane change of vehicles) in the lane L2 when determining whether or not the specified condition is satisfied. This is because it is considered that the driver performs a driving operation indicating the lane change intention after sufficiently confirming that there is no obstruction target at the lane change destination. According to this configuration, it is possible to change the lane by LTA with a simpler configuration.

Although the vehicle control device according to the embodiment has been described above, the present disclosure is not limited to the above-described embodiment, and various modifications can be made without departing from the object of the present disclosure.

For example, the specific condition may further include a condition that the predetermined-direction-side blinker is flashing by operating the blinker lever WL by the driver.

In addition, the present embodiment may be configured such that, when the specific condition is satisfied and the target position Ptgt is switched from the position P1 to the position P2 (P2a), whether or not the specific condition is satisfied is not performed for a predetermined waiting period. Accordingly, it is possible to suppress a situation in which a lane change is performed at once from the lane L1 to the second lane.

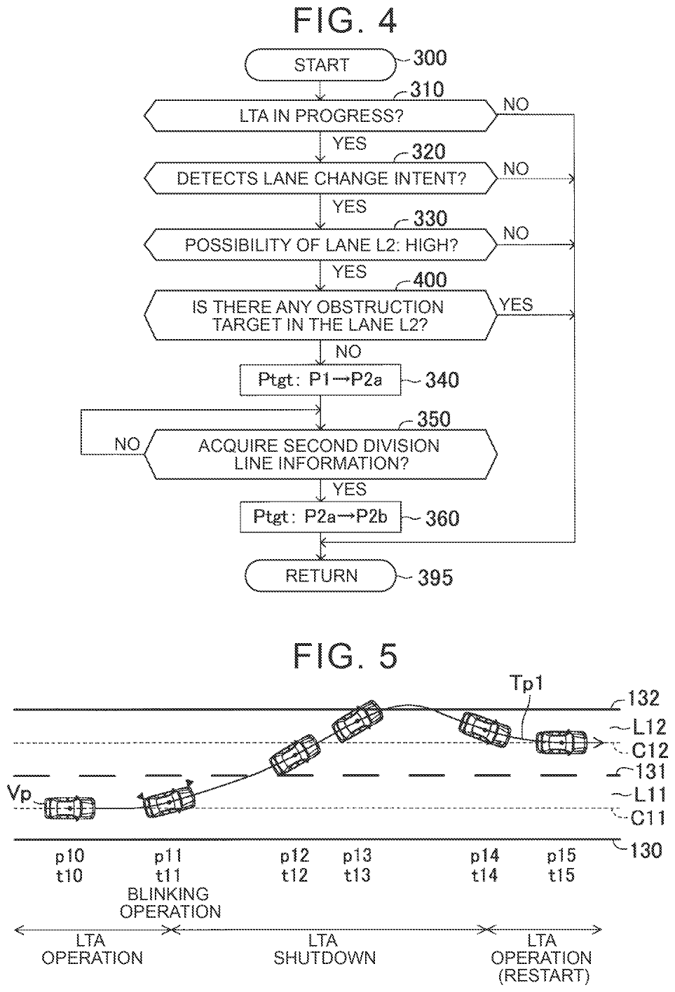

Further, as a modification, the vehicle control device may further include a side radar (side object detection device) capable of detecting a three-dimensional object existing on the side of the vehicle as a target. A detailed description will be given with reference to FIG. 4. In the flowchart of FIG. 4, the same step numbers are assigned to the same processes as those in the flowchart of FIG. 3. When a target is detected, the lateral radar calculates a relative relation between the vehicle and the target, and outputs the calculation result to ECU 10 as radar information. In this modification, the specified condition includes, in addition to the condition 1 and the condition 2, a condition that is satisfied when there is no obstruction target in the lane L2 as the condition 3. ECU 10 determines whether an obstruction target is present in the lane L2 based on the radar data (see S400 of FIG. 4). When there is no obstruction target in the lane L2 (S400: No), ECU 10 determines that the specified condition is satisfied due to the establishment of the condition 3, and switches the target position Ptgt of LTA from the position P1 to the position P2a (S340). On the other hand, when the obstruction target is present in the lane L2 (S400: Yes), ECU 10 determines that the specified condition is not satisfied due to the failure of the condition 3, and maintains the target position Ptgt of LTA in the position P1. In this instance, no lane change is made by LTA. According to this configuration, the lane change can be more safely performed while LTA is being executed. Note that a side object detection device (for example, a camera sensor) other than the side radar may be used.

Further, as another modification, the specific condition may be configured to further include at least one of the following conditions A to C.
(Condition A) The accelerator pedal operation amount (typically, the accelerator pedal stroke amount and/or the accelerator pedal stroke speed) based on the accelerator pedal operation of the driver is equal to or greater than a predetermined operation amount threshold.
(Condition B) The driver monitor camera installed in the vehicle cabin detects a scene in which the driver views the lane change destination.
(Condition C) Condition 1 is satisfied within a predetermined time from the time when the blinker on the predetermined direction side is flashing or when the blinker on the predetermined direction side changes from the on state to the off state.
   Generally, once the blinker starts blinking by a driver operating the blinker lever, the blinker will continue blinking until the blinker lever WL automatically returns to the neutral position. However, some drivers may turn off the blinker by operating the blinker lever WL themselves prior to the blinker lever WL automatically returning to the neutral position. In this case, the specific condition is not satisfied even though the driver intends to change the lane. Therefore, the specific condition may be configured to include the condition C (in particular, a condition subsequent to the condition C). According to this configuration, even when the driver turns off the blinker by his/her own blinker lever operation, the specific condition is satisfied if the condition 1 is satisfied within a predetermined time from the time when the blinker is turned off. Thus, this configuration can accommodate a wide range of blinker lever operations by the driver.

Furthermore, the present disclosure is also applicable to an autonomous vehicle configured to be able to select whether or not to execute autonomous driving control. Specifically, the present disclosure is applicable to a case where the execution of the automatic driving control is not selected.

What is claimed is:

1. A vehicle control device comprising:
an imaging device that is able to capture an image of a lane marking line extending in front of a vehicle and acquire lane marking line information related to the lane marking line; and
a control unit that is able to execute lane tracing assist control that assists a steering operation of a driver of the vehicle such that a traveling position of the vehicle is maintained at a predetermined target position in a lane width direction of a lane, based on the lane marking line information, wherein the control unit is configured to, during execution of the lane tracing assist control in a first lane, when a predetermined specific condition including a predetermined first condition that is satisfied when a lane change intention of the driver toward a predetermined direction is detected, and a predetermined second condition that is satisfied when there is a high possibility that a second lane adjacent to the first lane in the predetermined direction is present, is satisfied, switch the target position from a predetermined first position in the first lane to a predetermined second position in the second lane.

2. The vehicle control device according to claim 1, further comprising a vehicle state information acquisition device that is able to acquire vehicle state information related to a vehicle state of the vehicle, wherein the control unit is configured to:
during the execution of the lane tracing assist control in the first lane, sequentially calculate a length of a portion of the vehicle in the lane width direction, the portion being a portion that is estimated to deviate from the first lane after a predetermined specific time elapses, as an estimated deviation length, based on the lane marking line information and the vehicle state information; and
when the estimated deviation length is equal to or greater than a predetermined deviation length threshold value, detect the lane change intention in which an estimated deviation direction of the vehicle is the predetermined direction.

3. The vehicle control device according to claim 1, wherein the control unit is configured to, when the specific condition is satisfied during the execution of the lane tracing assist control in the first lane, set a position shifted, from the first position, in the predetermined direction along the lane width direction by a lane width of the first lane that is calculated based on first lane marking line information, as a second position and continue the lane tracing assist control, until second lane marking line information is acquired, and set a predetermined position in the second lane that is calculated based on the second lane marking line information, as the second position, after the second lane marking line information is acquired, the first lane marking line information being information on right and left lane marking lines defining the first lane, and the second lane marking line information being information on right and left lane marking lines defining the second lane.

4. The vehicle control device according to claim 1, further comprising a side object detection device that is able to detect an object present on a lateral side of the vehicle, wherein the specific condition further includes a predetermined third condition that is satisfied when an obstruction object that is highly likely to obstruct a lane change of the vehicle is not detected on the second lane by the side object detection device.

5. The vehicle control device according to claim 3, further comprising a side object detection device that is able to detect an object present on a lateral side of the vehicle, wherein the specific condition further includes a predetermined third condition that is satisfied when an obstruction object that is highly likely to obstruct a lane change of the vehicle is not detected on the second lane by the side object detection device.
